(19) United States
(12) Patent Application Publication
(10) Pub. No.: US 2005/0117343 A1
(43) Pub. Date: Jun. 2, 2005

(54) Night light

(76) Inventor: Richard Leifer, Melville, NY (US)

Correspondence Address: KEUSEY, TUTUNJIAN & BITETTO, P.C., 14 VANDERVENTER AVENUE, SUITE 128, PORT WASHINGTON, NY, 11050, US

(21) Appl. No.: 10/712,194

(22) Filed: Nov. 13, 2003

(51) Int. Cl. F21V 1/00

(52) U.S. Cl. 362/276

(57) ABSTRACT

A night light having a “night” operating mode and a “power failure” operating mode includes at least one light source and a reflective shield pivotally mounted to the night light housing. A battery backup provides power to the night light in the event power is lost at the outlet within which night light 10 is plugged. The reflective shield is movable to receive and reflect the light emanating from the light source in a downward direction for “night” operation and in an upward direction for “power failure” operating mode.

### BACKGROUND OF THE INVENTION

1. Field of the Invention

The present invention relates to night lights. More particularly, it relates to a night light that includes a battery back up and also doubles at a room light in the event of a power failure.

2. Description of the Prior Art

Night lights are generally used to provide a small amount of light in an area around an outlet and have many applications. Some exemplary applications are: 1) use in a hallway to provide some light for late night users of the hallway without requiring the use of a larger hallway light; 2) use in a child's bedroom to ease children's fear of the dark.

Night lights are plugged into a power outlet in the vicinity of where light is desired. However, in times of blackouts or power failures, these night lights fail. Thus, there is a need for a night light that has a power failure backup system, in addition to providing more light at times of power failure than when used as a night light.

### SUMMARY OF THE INVENTION

In accordance with one embodiment, the night light includes a light source, a power supply and a reflector. During a “night” mode of operation, the reflector is positioned so as to receive and reflect light from the light source downward from the night light housing. In a second “power failure” mode of operation, a controller connects an internal battery to the light source and illuminates the same. The reflector is moved to a second operating position so as to receive and reflect the light from the lights source upward into the surrounding area.

In other embodiments, a light sensor is incorporated into the housing and a manual on/off switch is provided.

According to yet other embodiments, a first “night” light source and a second “power failure” light source is provided. During operation, when “night” mode is being used the first light source is illuminated and the second light source is deactivated. The position of the reflector determines the amount and direction of the light reflection from the first and/or second light sources. When a power failure is detected, the controller switches to battery power and illuminates the second “power failure” light. In this mode, the reflector is positioned to reflect light upward and into the area around and above the night light.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings wherein like reference numerals denote similar components throughout the views:

FIG. 1 is a side view of the night light according to a first embodiment of the invention;

FIG. 2 is a block diagram of the night light as depicted in FIG. 1;

FIG. 3 is a side view of the night light according to a second embodiment of the invention;

FIG. 4 is a side view of the night light according to the second embodiment of the invention;

FIG. 5 is a block diagram of the night light according to the second embodiment of the invention;

FIG. 6 is a side view of the night light according to a third embodiment of the invention;

FIG. 7 is a side view of the night light according to the third embodiment of the invention;

FIG. 8 is a block diagram of the night light according to the third embodiment of the invention;

FIG. 9 is a side view of the night light according to a fourth embodiment of the invention; and

FIG. 10 is a block diagram of the night light according to the fourth embodiment of the invention.

### DETAILED DESCRIPTION OF PREFERRED EMBODIMENTS

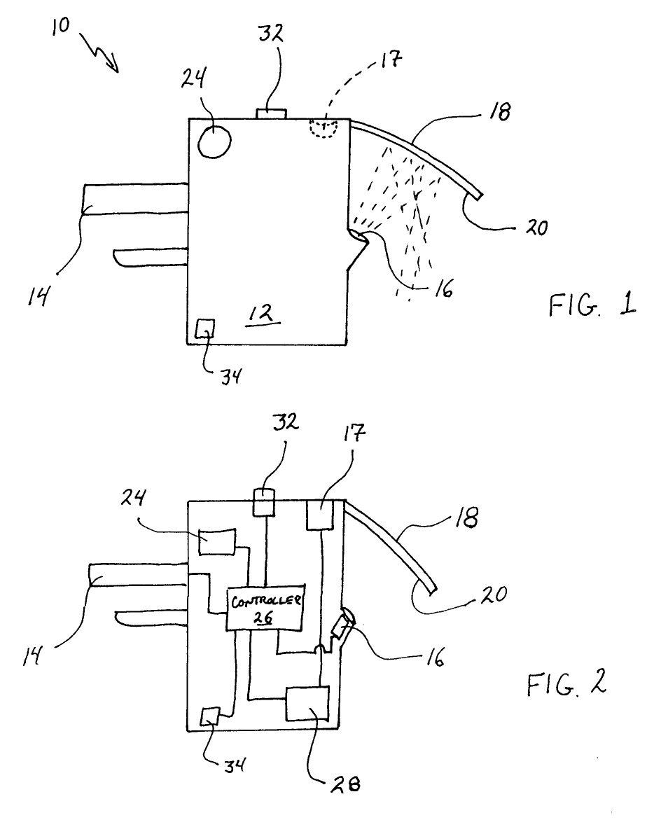

FIGS. 1 and 2 show the night light 10 according to a first embodiment of the invention. As shown, the night light 10 includes a housing 12, a plug 14, a light source 16 and a reflective shield 18 having a reflective surface 20. During operation, light source 16 directs light upward toward reflector 18 which received and reflects and disperses the received light downward into the area surrounding the night light.

A manual power switch 32 is provided to enable the manual turning on and off of the night light as desired. Power switch 32 may also function as an on/off switch when the night light is operating with the battery power supply 28. Night light 10 may also include a light sensor 24 for detecting the lack of light (darkness) and providing an automatic mode where night light 10 turns on when a predetermined level of darkness (i.e., lack of light) is detected by the light sensor 24. Light sensor 24 can be any suitable known photodetector.

An additional switch 34 disposed on the housing 12 is a manual power override and allows the user to manually disconnect the AC power supply and connect the battery back up 28 (discussed below). The manual override switch 34 can be used to turn the night light into a battery operated device for whatever application the user desires. The manual override switch 34 may be included of each of the embodiments disclosed herein.

FIG. 2 shows the internal workings of the night light 10 according to the invention. As shown, a controller 26 is connected to the switch 32, the plug 14, the light source 16 and a battery 28. In addition, when a light sensor 24 is implemented, it too is connected to controller 26. During operation, controller 26 provides power to light source 16 when AC power is provided through plug 14.

Night light 10 may also include as secondary light source 17 that is directed upward with respect to housing 12. The secondary light source 17 is connected to an internal battery 28 and is activated in the event a power failure occurs or the user actuates the manual override switch 34. When the power provided to night light 10 via plug 14 fails, controller 26 senses this condition and activates secondary light source 17 to provide light to the surrounding area of night light 10.

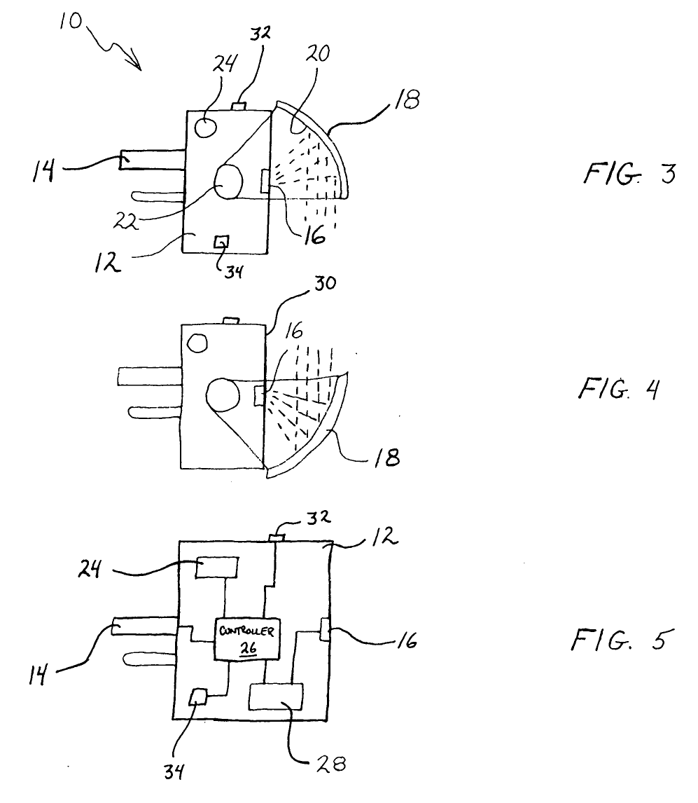

FIGS. 3-5 show a second embodiment of the night light 10 according to the invention. Night light 10 generally includes a housing 12 of any suitable shape, a power plug 14 and a light source 16. Housing 12 includes a reflector 18 that is pivotally mounted 22 to the housing. Reflector 18 is preferably opaque and does not allow light transmission there through. The inside side 20 of reflector 18 includes any suitable known reflective material adapted to receive and reflect light generated from light source 16.

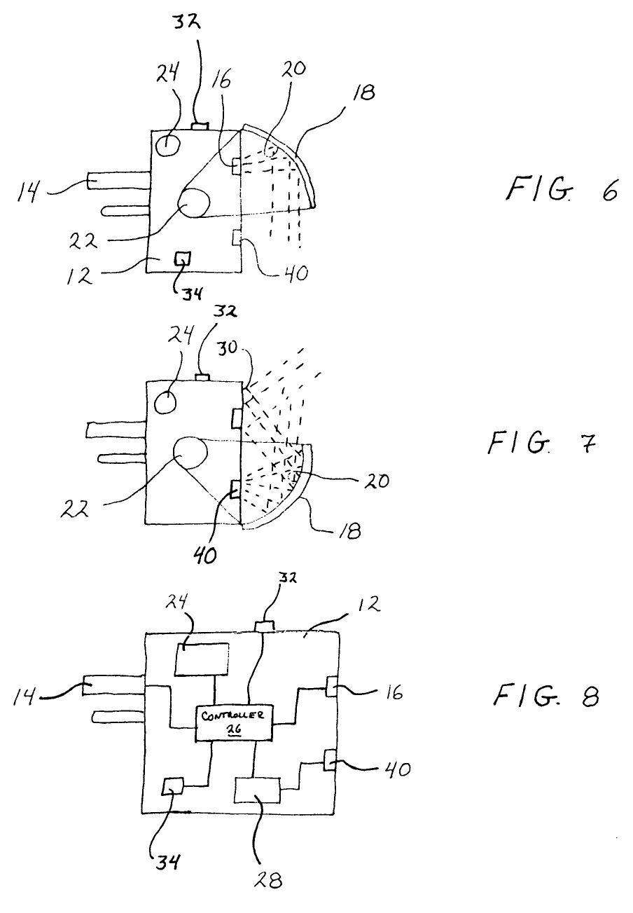

The light source 16 and 40 (FIGS. 6-8) can be any suitable known light source, such as, for example, incandescent, light emitting diode (LED), surface mount diode (SMD), etc. Those of ordinary skill will recognize that the principles and concepts disclosed by the invention can be implemented using various different light sources.

Night light 10 may also include a light sensor 24, an internal controller 26 and a battery power supply 28. Light sensor 24 detects the presence of light and can automatically turn on light source 16 through controller 26. A manual switch 32 can override the light sensor 24 and enables the manual switching on and off of the night light.

In accordance with one embodiment, a battery 28 is provided and connected to controller 28 and light source 16. Battery 28 can be any suitable known battery, including rechargeable type batteries. According to one mode of operation, when the power provided to night light 10 via plug 14 fails, controller 26 switches to battery 28 and light source 16 is illuminated by the battery. In this “power failure” mode, reflector 18 is moved to a second operable position (shown in FIG. 4) where the light emanating from light source 16 is reflected upward into the area surrounding the night light 10.

Reflector 18 is pivotally mounted 22 to housing 12 and in one mode can me a manually movable reflector. That is, the user is required to move reflector 18 to accommodate the various operating modes. In another embodiment, reflector 18 is mechanically connected to the housing and controller 26 moves reflector 18 into the “night” or “power failure” operating positions automatically. The mechanics of moving reflector 18 can be implemented using small gears and/or motors that are electronically connected to and controlled by controller 26. Those of ordinary skill in the art will recognize that other forms of mechanical implementation may be used without departing from the spirit of the invention.

FIG. 3 shows reflector 18 in a first operable position for “night” time applications. As shown, reflector 18 is pivoted upward such that the light emanating from light source 16 is substantially reflected downward with respect to the housing 12. In this manner, the night light 10 functions to provide a reduced amount of light to the area surrounding the outlet within which night light 10 is plugged into. Those of ordinary skill will recognize that the size and shape of reflector 18 may be varied without departing from the spirit of the present invention.

FIG. 4 shows night light 10 in a second operable position for power failure situations. In this “power failure” mode, reflector 18 is pivoted downward with respect to the housing 12 such that light emanating from light source 16 is reflected upward into the area surrounding the night light 10. In another embodiment, the surface 30 of housing

FIG. 5 shows a representative block diagram of the connections of light sensor 24, controller 26, battery 28, light source 16 and power switch 32. Other connections or variations thereof may also be implemented to provide the end result of the invention.

FIGS. 6-8 show the night light 10 according to a second embodiment of the invention. In this embodiment, night light 10 includes a first “night” light source 16 and a second “power failure” light source 40. During normal “night” light application mode, lights source 16 is illuminated and reflector 18 is positioned to reflect the light received downward, similar to the “night” mode described with respect to the embodiment of FIG. 1.

In “power failure” mode, controller 26 activates battery supply 28 and second light source 40 is illuminated, while light source 16 has been deactivated as a result of the power failure. In this mode, reflector 18 is moved to the position shown in FIG. 5 so as to receive and reflect light emanating from light source 40.

As described above, the position of reflector 18 may be manually or automatically controlled in order to provide the various operating modes of the night light 10 according to the invention. As shown in FIG. 7, housing 30 can further include a reflective surface to facilitate the reflection of light upward in the “power failure” mode of operation.

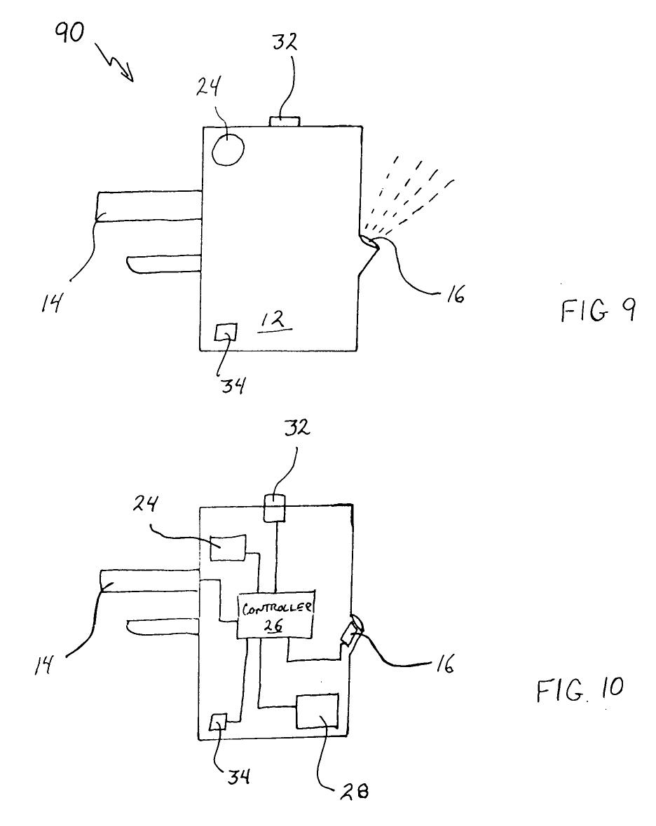

FIGS. 9 and 10 show another embodiment of night light 90 according to the invention. In this embodiment, light source 16 is a low voltage type light source, such as, for example a light emitting diode (LED) or surface mount diode (SMD) or any other known low voltage light source. The battery 28 is provided and connected to controller 26 to provide power to the light source 16 when AC power fails at the AC power connector 14. Since the light source 16 is designed to be a low voltage light source, battery 28 can provide power to the same for a significantly longer time than other incandescent or higher voltage light sources.

As described with reference to the aforementioned embodiments, a light sensor 24 may be included and connected to the controller 26 in order to detect the lack of light and illuminate the light source when automatic activation is chosen by the user. In addition, the controller 26 includes a power sensor or other power detection means for determining the presence of AC power from the AC power connector 14.

While there have been shown, described and pointed out fundamental novel features of the invention as applied to preferred embodiments thereof, it will be understood that various omissions, substitutions and changes in the form and details of the methods described and devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed, described or suggested form or embodiment as a general matter of design choice. It is the intention, therefore, to be limited only as indicated by the scope of the claims appended hereto.

1. A night light comprising:
a light source; and
a reflector for receiving and reflecting light from said light source.

2. The night light according to claim 1, further comprising a light sensor for detecting a lack of light.

3. The night light according to claim 1, further comprising an AC power connector for connecting the night light to an outlet.

4. The night light according to claim 3, further comprising:
a battery power source; and
a power sensor connected to said AC power connector for detecting AC power connected to the night light.

5. The night light according to claim 4, wherein said battery source is activated to power said light source upon detection of AC power loss through said AC power connector.

6. The night light according to claim 4, further comprising a manual override switch connected to said battery source and said light source for manually connecting said battery to said light source.

7. The night light according to claim 5, wherein said reflector is movable to reflect the received light upward from the night light.

8. The night light according to claim 5, wherein said reflector is movable to reflect the received light upward from the night light in response to the detection of AC power loss through said AC power connector.

9. The night light according to claim 1, wherein said light source comprises at least one selected from a group consisting of a light emitting diode (LED), a surface mount diode (SMD), and an incandescent light.

10. The night light according to claim 5, further comprising a secondary light source disposed in said housing and directed to illuminate an area around the night light in response to a detected power failure by said power sensor.

11. A night light comprising:
a first light source;
a second light source; and
a reflector for receiving and reflecting light generated by one of said light sources in response to power supplied to the night light.

12. The night light according to claim 11, further comprising:
an AC power supply;
a controller connected to said first and second light sources, said AC power supply and said reflector, said controller determining the presence of AC power through said AC power supply.

13. The night light according to claim 12, further comprising a battery source connected to said controller.

14. The night light according to claim 13, wherein upon detection of AC power failure at said AC power supply, said controller connects said battery source to said second light source and moves said refelector.

15. The night light according to claim 12, further comprising a light sensor for detecting light in an area surrounding the night light, wherein said first light source is connected to said AC power supply and illuminated when said light sensor detects a predetermined lack of light in the surrounding area.

16. The night light according to claim 14, wherein said controller moves said reflective shield to reflect light from said second light source into a surrounding area of the night light.

17. The night light according to claim 13, further comprising a manual override switch connected to said battery source, said controller and said light source for manually connecting said battery to said light source.

18. A night light comprising:
a light source; and
a reflector for receiving and reflecting light from said light source.
an AC power connector for connecting the night light to an outlet;
a battery power source; and
a sensor connected to said AC power connector for detecting AC power at the AC power connector.

19. The night light according to claim 18, further comprising:
a light sensor for detecting lack of light, said light sensor activating said light source upon detection of a predetermined level of darkness.

20. The night light according to claim 18, wherein said reflector is movable between a first night position and a second power failure condition.

21. The night light according to claim 18, further comprising a controller for switching between said AC power connector and said battery power source when an AC power failure is detected at said AC power connector.

22. A night light comprising:
a light source;
a power failure light source;
an AC power connector for connecting the night light to an outlet; and
a power sensor connected to said AC power connector for detecting AC power connected to the night light.

23. The night light according to claim 22, further comprising:
a light sensor for detecting lack of light, said light sensor activating said light source upon detection of a predetermined level of darkness.

24. The night light according to claim 22, further comprising a reflector positioned in front of said light source to reflect light away from said light source.

25. The night light according to claim 22, further comprising a reflector selectively positioned in front of said light source in response to detected AC power conditions at said AC power connector.

26. The night light according to claim 22, further comprising:
a battery power source; and
a controller connected to said battery power source, said controller activating said power failure light source upon detection of a power failure by said power sensor.

27. The night light according to claim 22, wherein said power failure light source comprises a light emitting diode (LED).

28. The night light according to claim 22, wherein said power failure light source comprises a surface mount diode (SMD).

29. The night light according to claim 23, further comprising a manual override switch connected to said battery and controller source for manually connecting said battery to said light source.

30. A night light comprising:
a light source;
an AC power connector for connecting the night light to an outlet;
a battery power source;
means for detecting the presence of power on said AC power connector; and
means for switching from the AC power connector to battery power when said detection means detects a power failure at said AC power connector.

31. The night light according to claim 30, wherein said light source comprises one selected from a group consisting of a light emitting diode (LED) and a surface mount diode (SMD).

32. The night light according to claim 30, wherein said detection means and said switching means comprises a controller.

33. The night light according to claim 30, further comprising a reflector positioned in front of said light source for reflecting the light from said light source away from the night light.

35. A night light comprising:
a light source;
an AC power connector for connecting the night light to an outlet;
a battery power source;
a manual override switch connected to said battery source and said light source for manually connecting said battery to said light source.

36. The night light according to 35, further comprising:
means for detecting the presence of power on said AC power connector.

37. The night light according to claim 36, further comprising:
means for switching from the AC power connector to battery power when said detection means detects a power failure at said AC power connector.
